(19) United States
(12) Patent Application Publication
(10) Pub. No.: US 2021/0264274 A1
(43) Pub. Date: Aug. 26, 2021

(54) SECRET SHARING WITH A NEURAL CRYPTOSYSTEM

(71) Applicant: Intel Corporation, Santa Clara, CA (US)

(72) Inventors: Raizy Kellerman, Jerusalem (IL); Michael Kounavis, Portland, OR (US); Omer Ben-Shalom, Rishon Le-Tzion (IL); Alex Nayshtut, Gan Yavne (IL); Oleg Pogorelik, Lapid (IL)

(73) Assignee: Intel Corporation, Santa Clara, CA (US)

(21) Appl. No.: 17/314,041

(22) Filed: May 6, 2021

(51) Int. Cl. G06N 3/08; H04L 9/08; G06N 3/063

(52) U.S. Cl. CPC G06N 3/08; G06N 3/063; H04L 9/085

(57) ABSTRACT

Partitioning a deep neural network (DNN) model into one or more sets of one or more private layers and one or more sets of one or more public layers, a set of one or more private layers being at least one key in a cryptographic system; and deploying the partitioned DNN model on one or more computing systems.

### FIELD

Embodiments relate generally to neural networks in computing systems, and more particularly, to sharing of a function as a secret using a neural network model as a cryptosystem in computing systems.

### BACKGROUND

Secret sharing (also called secret splitting) refers to methods for distributing a secret among a group of participants, each of whom is allocated a share of the secret. The secret can be reconstructed only when a sufficient number of shares, of possibly different types, are combined. Individual shares are of no use on their own. Neural cryptography is the use of neural networks (as universal approximators) to implement cryptography protocols such as key exchange, cryptanalysis, and encryption/decryption systems. Currently, neural cryptography is typically used for cryptanalysis, where neural networks learn encryption and decryption functions, or ciphertext indistinguishability, through adversarial training. Some approaches use a neural network as the cryptosystem, rather than the secret. These systems extend the encrypt/decrypt use case to enable additional output data besides the ciphertext but require the use of a user-provided key. Some approaches for secret sharing based on neural networks are designed to protect data (e.g., fixed length input data).

### BRIEF DESCRIPTION OF THE DRAWINGS

So that the manner in which the above recited features of the present embodiments can be understood in detail, a more particular description of the embodiments, briefly summarized above, may be had by reference to embodiments, some of which are illustrated in the appended drawings. It is to be noted, however, that the appended drawings illustrate only typical embodiments and are therefore not to be considered limiting of its scope. The figures are not to scale. In general, the same reference numbers will be used throughout the drawings and accompanying written description to refer to the same or like parts.

FIG. 1 illustrates a deep neural network (DNN) model-based cryptosystem according to some embodiments.

FIG. 2 is a flow diagram of DNN model training processing according to some embodiments.

FIG. 3 illustrates a system with a distributed DNN model according to one embodiment.

FIG. 4 is a system with a distributed DNN model according to another embodiment.

FIG. 5 is a system with a DNN model according to another embodiment.

FIG. 6 is an example of a mask regional convolutional neural network (MRCNN) model according to some embodiments.

FIG. 7 is an example of a model head according to some embodiments.

FIG. 8 illustrates a computing device executing a machine learning application, according to an embodiment.

FIG. 9 illustrates a machine learning software stack, according to an embodiment.

FIG. 10 illustrates an exemplary inferencing system on a chip (SOC) suitable for executing a machine learning application according to some embodiments.

### DETAILED DESCRIPTION

Embodiments of the present invention provide a method of sharing of a function as a secret using a deep neural network (DNN) model as a cryptosystem. Embodiments provide seamless integration with existing DNNs for machine learning (ML) applications and domains and enables secret sharing for a large range of functions. Embodiments enable “built-in” protection for the DNN model. Embodiments do not require a user-provided key.

Embodiments partition the DNN model into at least two parts, a set of public layers and a set of one or more private layers, which together build the secret in a shared form; having access to only parts of the DNN model does not provide access to the full DNN model. In embodiments, the public layers function as a public key and the private layers function as a corresponding private key. The partitioned DNN model is deployed on one or more computing systems to actively protect the secret, adversarial models which have read-only access to public layers are trained with substitutions replacing the protected private layers. Thus, embodiments transform the DNN model's middle representations into a scrambled domain that can be further used only if the full secret is accessible (e.g., access to public and private layers are required). Adversarial training is used to determine which layers of the DNN model are designated to be private, thereby ensuring that potential adversaries gain nothing when having access to only the public layers of the DNN model. Implementing this DNN model to multi-task network architectures enables different levels of secret sharing (e.g., one user may have access to a specific network task while not have access to another task of the protected network).

When the DNN model is deployed onsite at a user computing system, the owner of the DNN model would like to protect it. However, currently available runtime model protection methods are either limited (e.g., secure hardware has limited bandwidth) or consume too much runtime computing resources (e.g., homomorphic encryption is slower than plain execution by several orders of magnitude), and might not work for all operations (e.g., homomorphic encryption cannot handle non-polynomial operations). Making a portion of the DNN model secret while guaranteeing that the rest of the DNN model is useless can make the overall protection scheme effective and useful, so that protecting a small portion of the model (e.g., by protecting one or more private layers) is equivalent to protection of the whole model and effectively equals black-box (queries-only) access.

From the perspective of secret sharing of a function, embodiments enable handling of a wide range of functions. The present method can be applied with a plurality of keys (sets of one or more private layers) for multi-tasking networks. For example, the method is useful for a network with several branches, such as in a mask regional convolutional neural network (RCNN), when there is a basic “backbone” network that at a certain stage has forks for different processing tasks such as pose estimation, semantic segmentation and classification.

An advantage is that embodiments enable protecting a DNN model which occupies a large amount of memory using only a portion of the model (e.g., the private layers), since that even when the rest of the DNN model (e.g., the public layers) is fully compromised an adversary cannot gain any knowledge about the model beyond queries-only access.

In one example use case, the private layers of the DNN model are protectively embedded into an edge computing device (for example, a camera) such that unauthorized users cannot use the private layers unless they have the rest of the DNN model (both the public layers and the private layers) to perform training or inference. Thus, functional encryption is provided by embodiments because the key owner has access to a function (the private layers) rather than data.

In a simple example, a DNN model is separated into N parts, layer-wise, where N is a natural number. At least one set of one or more layers are chosen as private layers to be protected from unauthorized access while the remaining layers are public layers which are freely accessible. The private layers are protected by either a cryptographic method (e.g., they are transformed into a homomorphically-encrypted representation or sealed for processing within a protected execution environment such as Software Guard Extensions (SGX), commercially available from Intel Corporation). Since a goal is to protect the DNN model, one attack scenario is to rebuild the model using only the public layers. With embodiments, accurate reconstruction of the DNN model is impossible using only the public layers and adversarial training. The adversarial model has read only access to the public layers while the adversarial model includes substituted blocks that have replaced the private layers. In addition to the original DNN model task loss (e.g., classification with cross entropy loss) an adversarial loss term is added during model training which decreases the adversarial model's performance on a target task. The training processing transforms middle representations into a ‘scrambled’ domain that requires the private layers for processing, while leading the adversary model to arrive at a bad local minima. The adversarial model cannot achieve the results of the full original DNN model even after further training iterations.

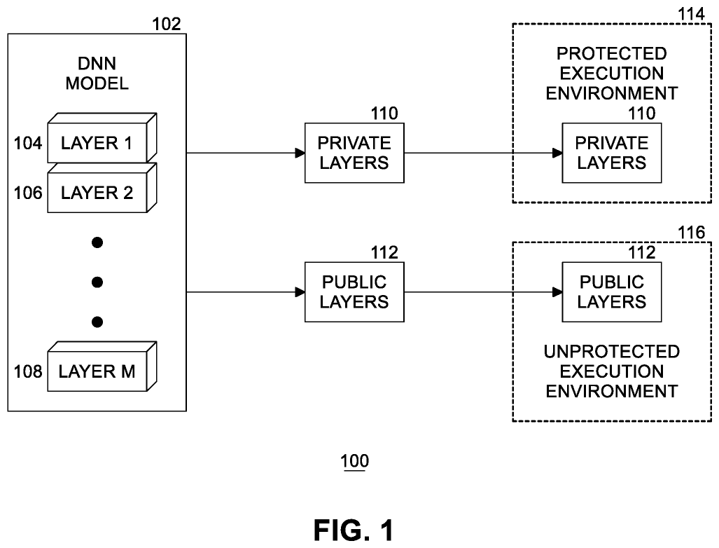

FIG. 1 illustrates a DNN model-based cryptosystem 100 according to some embodiments. DNN model 102 includes a plurality of layers, such as layer 1 104, layer 2 106, . . . layer M 108, where M is a natural number. Embodiments of the present invention partition DNN model 102 into at least one set of one or more private layers 110. DNN model 102 may be partitioned into a plurality of sets of private layers, and private layers in each set must be contiguous. The remaining layers of DNN model 102 (e.g., the layers not partitioned as private layers) are designated public layers 112. In embodiments, private layers 110 are executed on a computing device in a protected execution environment 114, and public layers are executed on a computing device in an unprotected execution environment 116. An authorized user with access to protected execution environment 114 can generate and/or use the complete DNN model 102 because the authorized user can access private layers 110 and public layers 112. An unauthorized user can only access public layers 112. Since private layers 110 of DNN model 102 are accessible only as authorized within protected execution environment 114, access to only public layers 112 in unprotected execution environment does not allow an adversary to generate and/or use the complete DNN model 102. Thus, DNN model 102 is protected.

In an embodiment, the private layers of the DNN model can be efficiently and effectively protected in protected execution environment 114 on secure computing hardware using methods such as Software Guard Extensions (SGX), commercially available from Intel Corporation, memory in a graphics processing unit (GPU) protected by a protected audio/video path (PAVP), by a trusted execution environment (TEE), by known cryptographic methods, or by other suitable security methods.

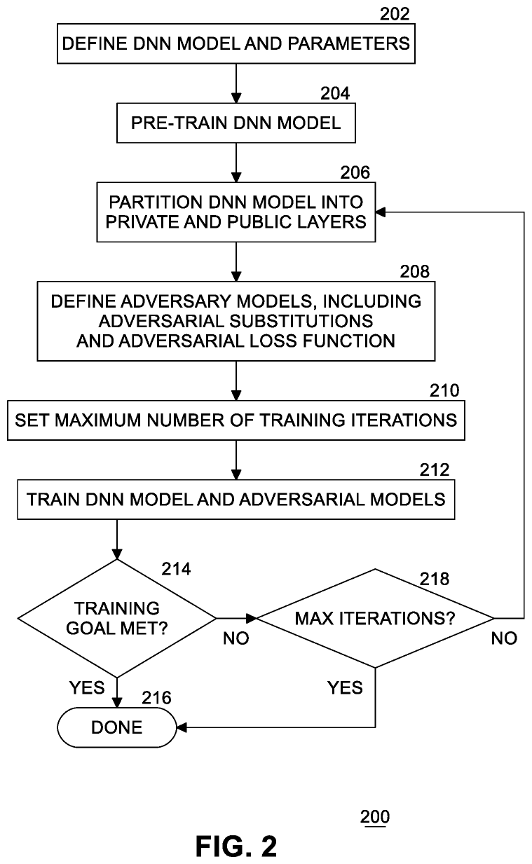

FIG. 2 is a flow diagram 200 of DNN model 102 training processing according to some embodiments. DNN model 102 is trained before being deployed. During a training phase, at block 202, a model developer (such as a machine learning application researcher, for example) defines a structure of DNN model 102 and parameters for DNN model 102. The structure may include a number of layers of the DNN model, types of layers, connections between layers, activations and a number of channels. DNN model parameters may include a DNN model loss function (e.g., a measure of cross-entropy for classification), a number of pre-training iterations, a maximum number of training iterations, and a target delta between the DNN model loss and an adversary's losses. At block 204, the model developer pre-trains the DNN model for a few iterations (also called “epochs”) so that the DNN model starts to learn but is not yet ready to be deployed. At block 206, the model developer partitions the DNN model 102 into at least one set of one or more private layers 110. These private layers will function as a secret (e.g., a private key) and will be protected when deployed. All remaining layers of the DNN model are public layers 112 (e.g., a public key). In other embodiments, there may be more than two partitions. For example, there may be three partitions comprising two sets of private layers and one set of public layers, four partitions comprising three sets of private layers and one set of public layers, and so on. This enables setting multiple sets of private layers as multiple private keys, respectively.

At block 208, the model developer defines one or more adversarial models. A goal of the one or more adversarial models is to attempt to reproduce the processing of DNN model 102 without having access to private layers 110 and having only read access to public layers 112. Each adversary model includes all the layers of DNN model 102 but has private layers 110 replaced with one or more adversarial substitutions. In an embodiment, each adversarial substitution comprises one or more layers. Each adversarial substitution may have a different power, which is derived from the structure of the adversarial substitution (e.g., number and types of layers). An adversarial substitution includes an adversarial loss function. An adversarial substitution may have the same structure of a private layer or a different structure.

In embodiments, the adversarial loss function maximizes the adversary loss or makes the adversary correct in approximately 50% of the time. In one embodiment, the adversary loss function is (C/2−the adversary error rate)/(C/2)\hat{ }2, where C is a number of classes in a DNN model, C being a natural number.

Thus, DNN model 102 has a DNN model loss function and an adversarial loss term (from an adversarial loss function for each adversarial model) which aims to maximize the loss of the adversary models. An adversary may attempt to guess the structure of the private layers and create adversarial substitutions with the same or a different structure.

Assume a DNN model (“Alice”) is trained while being aware to an adversary in a competitive way. The DNN model has shared parts, which function as the public key, and private parts, which function as the private key. At least one additional adversary model (“Eve”) has access to the shared parts while the adversarial model has a substitutional sub-model to replace or reconstruct the private key. Alice has full access to all the model parts for both reading and updating, while Eve has read only access to the shared parts. Another way to consider this scenario is that Eve is trying to perform unconventional transfer learning—some parts of the model are frozen, while Eve tries to use the model for performing a selected task using knowledge from parts of Alice's model.

For example, a model may have the configuration of Table 1 below.

TABLE 1

| | | Shared with both Alice |
|---|---|---|
| Layer | Layer parameters | and Eve |
| Conv1 | 5 × 5 × 32 | Shared |
| Conv2 | 3 × 3 × 32 | Shared |
| Conv3 | 3 × 3 × 64 | Eve has a substitute |
| Conv4 | 3 × 3 × 64 | Eve has a substitute |
| Dense1 | 512 | Eve has a substitute |
| Dense2 | 10 (for CIFARIO) | Shared |

In one sample training scenario, several adversaries are created, some with more expressive power (e.g., a wider receptive field, more channels per layer, more layers) and trained while the adversarial loss is a combination of all participating adversaries. Since models may be publicly available, usually as open-source implementations with pretrained weights, a threat model may assume that the training data is the main asset which the adversary can't easily achieve (otherwise, the adversary can train a model on its own) and hence the adversaries, in one embodiment, are not provided with the full training set of data initially but with only 70% of the original train set.

For training purposes, DNN model 102 may be updated, for example, with one or more adversaries as described in table below:

TABLE 2

| | | Shared with | | | |
|---|---|---|---|---|---|
| | | both Alice | | | |
| | | and Eve | | | |
| | Layer | (Adversary | Adversary | Adversary | Adversary |
| Layer | parameters | no. 1) | no. 2 | no. 3 | no. 4 |
| Conv1 | 5 × 5 × 32 | Shared | Shared | Shared | Shared |
| Conv2 | 3 × 3 × 32 | Shared | Shared | Shared | Shared |
| Conv3 | 3 × 3 × 64 | Eve has a | ResNet-like | Inception-like | 3 × 3 × 128 |
| | | substitute | layers with 3 | layers: | → |
| | | | blocks of | Parallel | 3 × 3 × 128 |
| | | | 3 × 3 × (64, 128, | conv1 × 1, | (filters |
| | | | 512) filters | conv1 × 1, | doubled |
| | | | | conv3 × 3, | than the |
| | | | | connected to | private |
| | | | | conv3 × 3, | model's |
| | | | | conv5 × 5, | equivalents) |
| | | | | conv1 × 1 and | |
| | | | | additional | |
| | | | | conv1 × 1 that | |
| | | | | gets input | |
| | | | | from Conv2, | |
| | | | | then | |
| | | | | concatenated | |
| Conv4 | 3 × 3 × 64 | Eve has a | | | |
| | | substitute | | | |
| Dense1 | 512 | Eve has a | | | |
| | | substitute | | | |
| Dense2 | 10 (for | Shared | Shared | Shared | Shared |
| | CIFAR10) | | | | |

At block 210, the model developer sets a maximum number of training iterations.

At block 212, DNN model 102 and the one or more adversarial models are trained “side-by-side” on the same set of input data. That is, DNN model 102 is trained alongside a first adversarial model, then trained again alongside a second adversarial model (if there is one), and so on. DNN model 102 is trained for a first number of iterations, and each adversarial model is trained for a second number of iterations. In an embodiment the first number of iterations is equal to the second number of iterations. In another embodiment, the first number of iterations is different than the second number of iterations. In an embodiment, the number of iterations that an adversarial model is trained is different for one or more adversarial models than for other adversarial models. In an embodiment, the first number of iterations and the second number of iterations may be set by the model developer. During the training iterations, the losses for the DNN model at each iteration and for each of the one or more adversarial models at each iteration are saved.

At block 214, the model developer determines if a training goal has been met. In one embodiment, a training goal is defined as whether a minimum of the DNN model losses minus a minimum of the adversarial model losses is less than a target delta value. In other embodiments, other training goals may be used, such as DNN model 102 having an empirically known loss and the adversary is only as good as random guesses. If so, model training processing is done at block 216. If not, at block 218 if the maximum number of iterations has been reached, then model training processing is done at block 216. If not, model training processing continues with a new partitioning of the DNN model layers at block 206. The model developer may repeat partitioning, setting of the maximum number of training iterations, and training processing as desired.

After DNN model 102 has been partitioned into private layers 110 and public layers 112 and DNN model 102 is trained, the model developer deploys DNN model 102 on one or more target computing systems, ensuring that private layers 110 are deployed and executable only within protected execution environment 114 (e.g., layers are sealed and only SGX instructions can access the layers, or the layers are homomorphically encrypted). Deployment may include distributing DNN model 102 to one or more computing systems operated by one or more users other than the model developer.

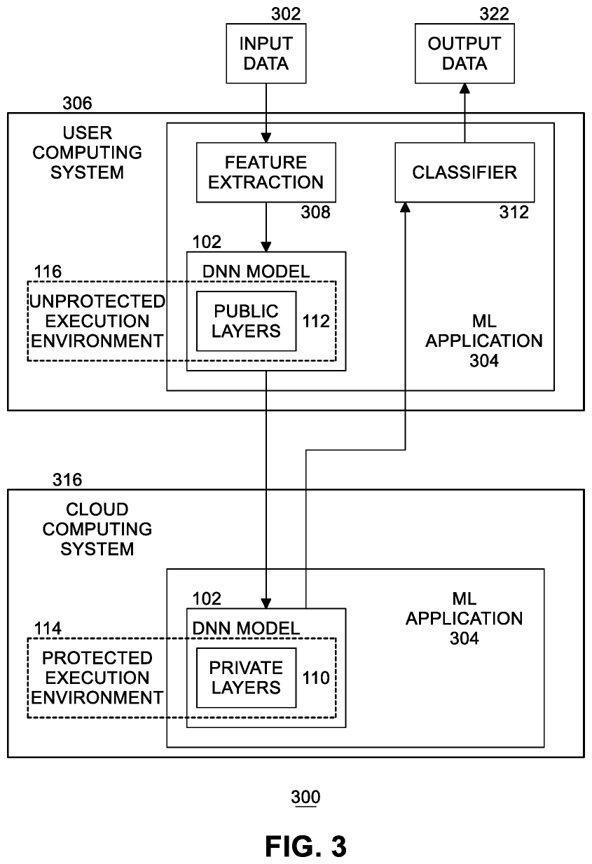

Once deployed on one or more computing systems, partitioned DNN model 102 may be used for inference processing in a ML application. FIG. 3 illustrates a system 300 with a distributed DNN model according to one embodiment. In this example, public layers 112 are executed on a user computing system 306 and private layers 110 are executed on a cloud computing system 316. This architecture may be used, for example, when user computing system 306 is untrusted but at least a portion of cloud computing system 316 is trusted. Input data 302 is received by user computing system 306. Input data 302 comprises any set of data to be processed by DNN model 102 in a ML application (such as image data captured by a camera, for example). In one embodiment, ML application 304 running on user computing system 306 includes DNN model 102, feature extraction 208, and classifier 312. Feature extraction is used, optionally, to extract features from input data 302 and forward at least those features to DNN model 102. In this embodiment, DNN model 102 includes a first partition including public layers 112 being executed in unprotected execution environment 116 on user computing system 306.

Intermediate output data from execution of public layers 112 is forwarded over a communications network (such as an intranet or the Internet, not shown) to DNN model 102 of ML application 304 running on cloud computing system 316. In this embodiment, DNN model 102 includes a second partition including private layers 110 being executed in protected execution environment 114 on cloud computing system 316. Thus, there are two partitions of one DNN model 102. For example, if a model is consisted of layer1->layer2->layer3->layer4, one partition has only layer1 and layer2, and the other partition has only layer3 and layer4. Output data from private layers 110 is forwarded over the communications network (not shown) to classifier 312 in ML application 304 on user computing system 306 for further processing. Classifier 312 then produces output data 322.

By partitioning DNN model 102 into public layers 112 being executed in an unprotected execution environment 116 on untrusted user computing system 306 and private layers 110 being executed in protected execution environment 114 on trusted cloud computing system 316, better security is provided for DNN model 102.

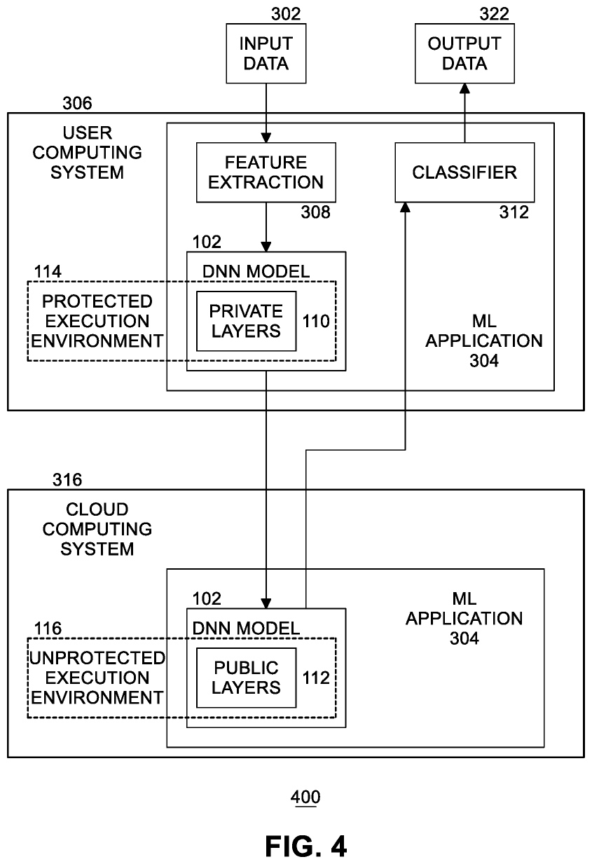

FIG. 4 is a system 400 with a distributed DNN model according to another embodiment. In this example, private layers 110 are executed on a user computing system 306 and public layers 111 are executed on a cloud computing system 316. This architecture may be used, for example, when user computing system 306 is trusted but cloud computing system 316 is untrusted. Input data 302 is received by user computing system 306. In this embodiment, DNN model 102 includes a first partition including private layers 110 being executed in protected execution environment 114 on user computing system 306.

Intermediate output data from execution of private layers 110 is forwarded over a communications network (not shown) to DNN model 102 of ML application 304 running on cloud computing system 316. In this embodiment, DNN model 102 includes a second partition including public layers 112 being executed in unprotected execution environment 116 on cloud computing system 316. Output data from public layers 112 is forwarded over the communications network (not shown) to classifier 312 in ML application 304 on user computing system 306 for further processing. Classifier 312 then produces output data 322.

By partitioning DNN model 102 into public layers 112 being executed in an unprotected execution environment 116 on untrusted cloud computing system 316 and private layers 110 being executed in protected execution environment 114 on trusted user computing system 306, better security is provided for DNN model 102.

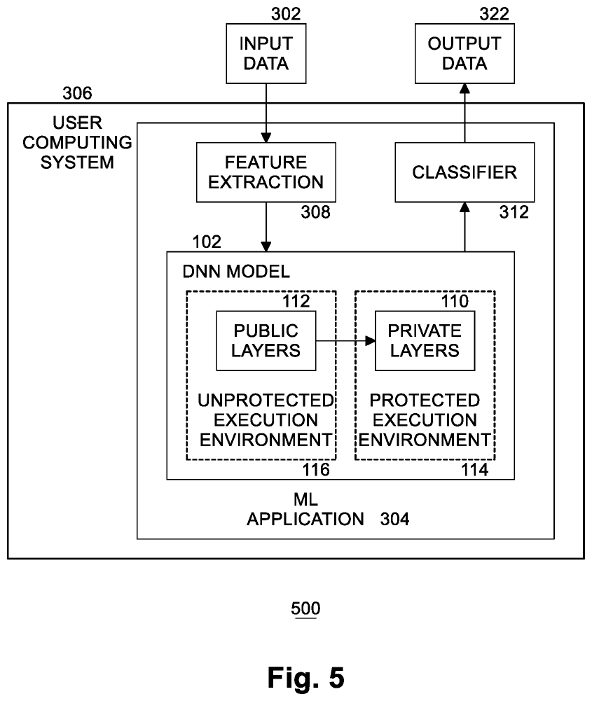

FIG. 5 is a system with a DNN model according to another embodiment. In this example, both private layers 110 and public layers 112 are executed on a user computing system 306. This architecture may be used, for example, when at least a portion of user computing system 306 is trusted but other portions of user computing system 306 are untrusted. Input data 302 is received by user computing system 306. In this embodiment, DNN model 102 includes a first partition including public layers 112 being executed in unprotected execution environment 116 on user computing system 306.

In this embodiment, DNN model 102 includes a second partition including private layers 110 being executed in protected execution environment 114 on user computing system 306. Intermediate output data from execution of public layers 110 is forwarded to private layers 110. Output data from private layers 110 is forwarded to classifier 312 in ML application 304 on user computing system 306 for further processing. Classifier 312 produces output data 322.

By partitioning DNN model 102 into public layers 112 being executed in an unprotected execution environment 116 on user computing system 306 and private layers 110 being executed in protected execution environment 114 on user computing system 306, better security is provided for DNN model 102.

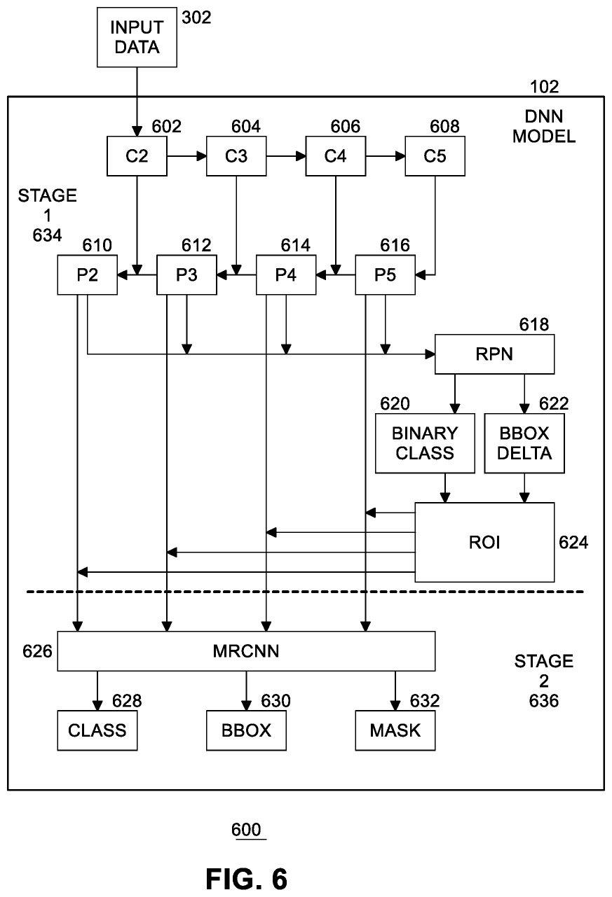

In some embodiments, multiple keys may be used. FIG. 6 is an example of a mask regional convolutional neural network (MRCNN) model 600 according to some embodiments. MRCNN model 600 can perform both classification (e.g., determining what is in an image as input data), detection (e.g., providing bounding boxes of pixel indices for each object found in the image), and masking (e.g., outputting another image with the same resolution of the input data where each pixel has a value that represents the object class the pixel belongs to.

MRCNN model 600 works with a “backbone” comprising a sequence of layers that is common to all sub-tasks (classification, detection and masking), and then splits into several “heads” so that the output data of the common backbone is sent to each head for independent processing. Each head is also a sequence of layers, that has its own task specific loss function.

As shown in FIG. 6, the model includes two stages: stage 1 634 and stage 2 636. Input data 302 is passed through a series of components C2 602, C3 604, C4 606, and C5 608 and P2 610, P3 612, P4 614, and P616. Components denoted “C” comprise a regular bottom-up pathway, which may be any convolutional neural network (CNN) (such as ResNet, which extracts features from raw images perform), and components denoted “P” comprise a top-bottom pathway that generates a feature pyramid map which has similar size as the bottom-up pathway. The bottom-up and top-down connections help to maintain rich semantic features across resolutions. The “C” and “P” components describe a feature pyramid network (FPN) structure.

Output data from the P components is passed to region proposal network (RPN) 618 which performs region proposal processing (that it, RPN proposes regions of interest and bounding boxes which are likely to contain objects). Output data from RPN 618 is passed to binary classification (class) 620 to determine whether the proposal is likely to contain an object and to bounding box (bbox) delta 622 to correct the boundaries of the bounding box. The correctness is formed as delta from predefined anchors. Processing by RPN 618, binary class 620 and bbox delta 622 determine one or more regions of interest (ROI) 624. ROI 624 comprises pairs of bbox deltas and their likelihood to contain an object.

An example of one head is shown in stage 2 636 as MRCNN 626, which passed output data to class 628, bbox 630, and mask 632. Class head: 628 performs classification to determine a single (most dominant) object in the image from input data 302. Bbox head 630 performs localization to determine an array of bounding boxes of objects, each bbox having its own classification. Mask 632 performs semantic segmentation to determine an image of the same size as the input image, with each pixel having a different value according to the object the pixel belongs to.

There may be any number of heads in MRCNN model 600.

In an embodiment, each head is protected separately, with different “keys”—that is, a different sequence of private layers that are selected (or injected) to the sequence of the layers that compose that head. Each head operates independently of other heads.

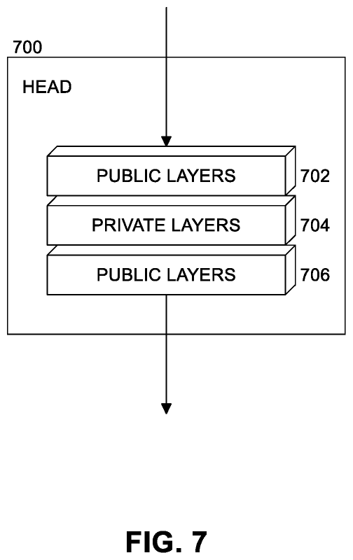

FIG. 7 is an example of a model head 700 according to some embodiments. Head 700 includes a plurality of layers, which each layer performing a function (e.g., classification, bounding box determination, masking, etc.). At least one of the layers of head 700 is chosen to be a set of private layers 704. Remaining layers of head 700 are designated as public layers 702, 706. Private layers 704 are the key for head 700. Each head can be partitioned to contain a unique private and public set of layers. In one scenario, a user may obtain the private layers for a specific head while not having access to the private layers of other heads.

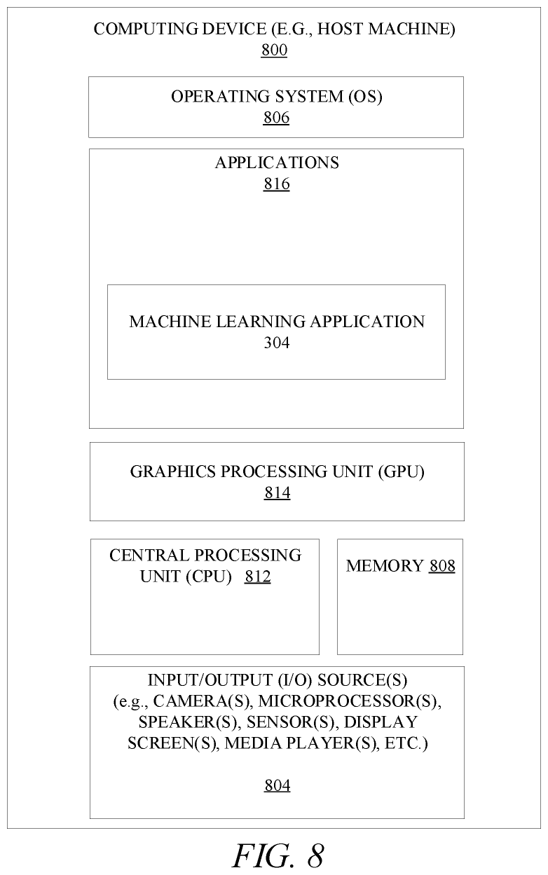

FIG. 8 illustrates one embodiment of a computing device 800 (e.g., a host machine) executing an application 816, including ML application 304. Computing device 800 (e.g., smart wearable devices, virtual reality (VR) devices, head-mounted display (HMDs), mobile computers, Internet of Things (IoT) devices, laptop computers, desktop computers, server computers, smartphones, etc.) is shown as ML application 304.

In some embodiments, some or all of ML application 304 may be hosted by or part of firmware of graphics processing unit (GPU) 814. In yet other embodiments, some or all of ML application 304 may be hosted by or be a part of firmware of central processing unit (“CPU” or “application processor”) 812.

In yet another embodiment, ML application 304 may be hosted as software or firmware logic by operating system (OS) 806. In yet a further embodiment, ML application 304 may be partially and simultaneously hosted by multiple components of computing device 100, such as one or more of GPU 814, GPU firmware (not shown in FIG. 8), CPU 812, CPU firmware (not shown in FIG. 8), operating system 806, and/or the like. It is contemplated that ML application 304 or one or more of the constituent components may be implemented as hardware, software, and/or firmware.

Throughout the document, term “user” may be interchangeably referred to as “viewer”, “observer”, “person”, “individual”, “end-user”, and/or the like. It is to be noted that throughout this document, terms like “graphics domain” may be referenced interchangeably with “graphics processing unit”, “graphics processor”, or simply “GPU” and similarly, “CPU domain” or “host domain” may be referenced interchangeably with “computer processing unit”, “application processor”, or simply “CPU”.

Computing device 800 may include any number and type of communication devices, such as large computing systems, such as server computers, desktop computers, etc., and may further include set-top boxes (e.g., Internet-based cable television set-top boxes, etc.), global positioning system (GPS)-based devices, etc. Computing device 800 may include mobile computing devices serving as communication devices, such as cellular phones including smartphones, personal digital assistants (PDAs), tablet computers, laptop computers, e-readers, smart televisions, television platforms, wearable devices (e.g., glasses, watches, bracelets, smartcards, jewelry, clothing items, etc.), media players, etc. For example, in one embodiment, computing device 800 may include a mobile computing device employing a computer platform hosting an integrated circuit (“IC”), such as system on a chip (“SoC” or “SOC”), integrating various hardware and/or software components of computing device 800 on a single chip.

As illustrated, in one embodiment, computing device 800 may include any number and type of hardware and/or software components, such as (without limitation) GPU 814, a graphics driver (also referred to as “GPU driver”, “graphics driver logic”, “driver logic”, user-mode driver (UMD), UMD, user-mode driver framework (UMDF), UMDF, or simply “driver”) (not shown in FIG. 8), CPU 812, memory 808, network devices, drivers, or the like, as well as input/output (I/O) sources 804, such as touchscreens, touch panels, touch pads, virtual or regular keyboards, virtual or regular mice, ports, connectors, etc.

Computing device 800 may include operating system (OS) 806 serving as an interface between hardware and/or physical resources of the computer device 800 and a user. It is contemplated that CPU 812 may include one or more processors, such as processor(s) 802 of FIG. 8, while GPU 814 may include one or more graphics processors (or multiprocessors).

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, and the like, may be used interchangeably throughout this document. Also, terms like “job”, “input”, “request”, “message”, and the like, may be used interchangeably throughout this document.

It is contemplated that some processes of the graphics pipeline as described herein are implemented in software, while the rest are implemented in hardware. A graphics pipeline (such as may be at least a part of ML application 304) may be implemented in a graphics coprocessor design, where CPU 812 is designed to work with GPU 814 which may be included in or co-located with CPU 812. In one embodiment, GPU 814 may employ any number and type of conventional software and hardware logic to perform the conventional functions relating to graphics rendering as well as novel software and hardware logic to execute any number and type of instructions.

Memory 808 may include a random-access memory (RAM) comprising application database having object information. A memory controller hub (not shown in FIG. 8) may access data in the RAM and forward it to GPU 814 for graphics pipeline processing. RAM may include double data rate RAM (DDR RAM), extended data output RAM (EDO RAM), etc. CPU 812 interacts with a hardware graphics pipeline to share graphics pipelining functionality.

Processed data is stored in a buffer in the hardware graphics pipeline, and state information is stored in memory 808. The resulting image is then transferred to I/O sources 804, such as a display component for displaying of the image. It is contemplated that the display device may be of various types, such as Cathode Ray Tube (CRT), Thin Film Transistor (TFT), Liquid Crystal Display (LCD), Organic Light Emitting Diode (OLED) array, etc., to display information to a user.

Memory 808 may comprise a pre-allocated region of a buffer (e.g., frame buffer); however, it should be understood by one of ordinary skill in the art that the embodiments are not so limited, and that any memory accessible to the lower graphics pipeline may be used. Computing device 800 may further include an input/output (I/O) control hub (ICH) (not shown in FIG. 8), as one or more I/O sources 804, etc.

CPU 812 may include one or more processors to execute instructions in order to perform whatever software routines the computing system implements. The instructions frequently involve some sort of operation performed upon data. Both data and instructions may be stored in system memory 808 and any associated cache. Cache is typically designed to have shorter latency times than system memory 808; for example, cache might be integrated onto the same silicon chip(s) as the processor(s) and/or constructed with faster static RAM (SRAM) cells whilst the system memory 808 might be constructed with slower dynamic RAM (DRAM) cells. By tending to store more frequently used instructions and data in the cache as opposed to the system memory 808, the overall performance efficiency of computing device 800 improves. It is contemplated that in some embodiments, GPU 814 may exist as part of CPU 812 (such as part of a physical CPU package) in which case, memory 808 may be shared by CPU 812 and GPU 814 or kept separated.

System memory 808 may be made available to other components within the computing device 800. For example, any data (e.g., input graphics data) received from various interfaces to the computing device 800 (e.g., keyboard and mouse, printer port, Local Area Network (LAN) port, modem port, etc.) or retrieved from an internal storage element of the computer device 800 (e.g., hard disk drive) are often temporarily queued into system memory 808 prior to being operated upon by the one or more processor(s) in the implementation of a software program. Similarly, data that a software program determines should be sent from the computing device 800 to an outside entity through one of the computing system interfaces, or stored into an internal storage element, is often temporarily queued in system memory 808 prior to its being transmitted or stored.

Further, for example, an ICH may be used for ensuring that such data is properly passed between the system memory 808 and its appropriate corresponding computing system interface (and internal storage device if the computing system is so designed) and may have bi-directional point-to-point links between itself and the observed I/O sources/devices 804. Similarly, an MCH may be used for managing the various contending requests for system memory 808 accesses amongst CPU 812 and GPU 814, interfaces and internal storage elements that may proximately arise in time with respect to one another.

I/O sources 804 may include one or more I/O devices that are implemented for transferring data to and/or from computing device 800 (e.g., a networking adapter); or, for a large scale non-volatile storage within computing device 800 (e.g., hard disk drive). User input device, including alphanumeric and other keys, may be used to communicate information and command selections to GPU 814. Another type of user input device is cursor control, such as a mouse, a trackball, a touchscreen, a touchpad, or cursor direction keys to communicate direction information and command selections to GPU 814 and to control cursor movement on the display device. Camera and microphone arrays of computer device 800 may be employed to observe gestures, record audio and video and to receive and transmit visual and audio commands.

Computing device 800 may further include network interface(s) to provide access to a network, such as a LAN, a wide area network (WAN), a metropolitan area network (MAN), a personal area network (PAN), Bluetooth, a cloud network, a mobile network (e.g., 3rd Generation (3G), 4th Generation (4G), etc.), an intranet, the Internet, etc. Network interface(s) may include, for example, a wireless network interface having antenna, which may represent one or more antenna(e). Network interface(s) may also include, for example, a wired network interface to communicate with remote devices via network cable, which may be, for example, an Ethernet cable, a coaxial cable, a fiber optic cable, a serial cable, or a parallel cable.

Network interface(s) may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported. In addition to, or instead of, communication via the wireless LAN standards, network interface(s) may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

Network interface(s) may include one or more communication interfaces, such as a modem, a network interface card, or other well-known interface devices, such as those used for coupling to the Ethernet, token ring, or other types of physical wired or wireless attachments for purposes of providing a communication link to support a LAN or a WAN, for example. In this manner, the computer system may also be coupled to a number of peripheral devices, clients, control surfaces, consoles, or servers via a conventional network infrastructure, including an Intranet or the Internet, for example.

It is to be appreciated that a lesser or more equipped system than the example described above may be preferred for certain implementations. Therefore, the configuration of computing device 800 may vary from implementation to implementation depending upon numerous factors, such as price constraints, performance requirements, technological improvements, or other circumstances. Examples of the electronic device or computer system 800 may include (without limitation) a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

Embodiments may be implemented as any or a combination of: one or more microchips or integrated circuits interconnected using a parent board, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more tangible non-transitory machine-readable media having stored thereon machine-executable instructions that, when executed by one or more machines such as a computer, network of computers, or other electronic devices, may result in the one or more machines carrying out operations in accordance with embodiments described herein. A tangible non-transitory machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

Machine Learning Overview

A machine learning algorithm is an algorithm that can learn based on a set of data. Embodiments of machine learning algorithms can be designed to model high-level abstractions within a data set. For example, image recognition algorithms can be used to determine which of several categories to which a given input belongs; regression algorithms can output a numerical value given an input; and pattern recognition algorithms can be used to generate translated text or perform text to speech and/or speech recognition.

An exemplary type of machine learning algorithm is a neural network. There are many types of neural networks; a simple type of neural network is a feedforward network. A feedforward network may be implemented as an acyclic graph in which the nodes are arranged in layers. Typically, a feedforward network topology includes an input layer and an output layer that are separated by at least one hidden layer. The hidden layer transforms input received by the input layer into a representation that is useful for generating output in the output layer. The network nodes are fully connected via edges to the nodes in adjacent layers, but there are no edges between nodes within each layer. Data received at the nodes of an input layer of a feedforward network are propagated (i.e., “fed forward”) to the nodes of the output layer via an activation function that calculates the states of the nodes of each successive layer in the network based on coefficients (“weights”) respectively associated with each of the edges connecting the layers. Depending on the specific model being represented by the algorithm being executed, the output from the neural network algorithm can take various forms.

Before a machine learning algorithm can be used to model a particular problem, the algorithm is trained using a training data set. Training a neural network involves selecting a network topology, using a set of training data representing a problem being modeled by the network, and adjusting the weights until the network model performs with a minimal error for all instances of the training data set. For example, during a supervised learning training process for a neural network, the output produced by the network in response to the input representing an instance in a training data set is compared to the “correct” labeled output for that instance, an error signal representing the difference between the output and the labeled output is calculated, and the weights associated with the connections are adjusted to minimize that error as the error signal is backward propagated through the layers of the network. The network is considered “trained” when the errors for each of the outputs generated from the instances of the training data set are minimized.

The accuracy of a machine learning algorithm can be affected significantly by the quality of the data set used to train the algorithm. The training process can be computationally intensive and may require a significant amount of time on a conventional general-purpose processor. Accordingly, parallel processing hardware is used to train many types of machine learning algorithms. This is particularly useful for optimizing the training of neural networks, as the computations performed in adjusting the coefficients in neural networks lend themselves naturally to parallel implementations. Specifically, many machine learning algorithms and software applications have been adapted to make use of the parallel processing hardware within general-purpose graphics processing devices.

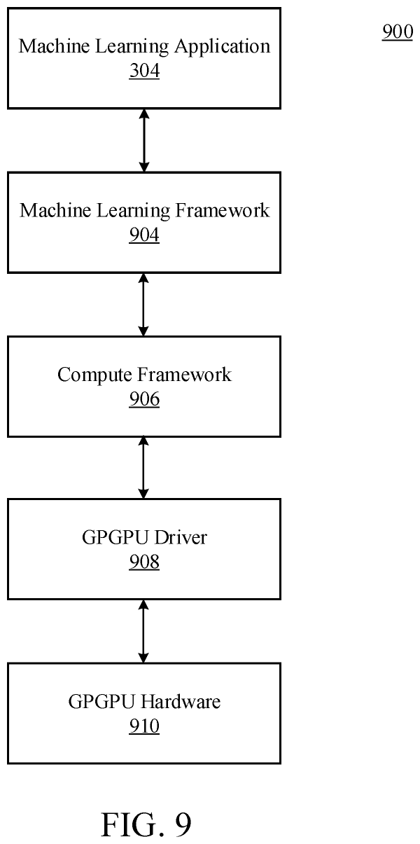

FIG. 9 is a generalized diagram of a machine learning software stack 900. A machine learning application 304 can be configured to train a neural network using a training dataset or to use a trained deep neural network to implement machine intelligence. The machine learning application 304 can include training and inference functionality for a neural network and/or specialized software that can be used to train a neural network before deployment. The machine learning application 304 can implement any type of machine intelligence including but not limited to image recognition, mapping and localization, autonomous navigation, speech synthesis, medical imaging, or language translation.

Hardware acceleration for the machine learning application 304 can be enabled via a machine learning framework 904. The machine learning framework 904 can provide a library of machine learning primitives. Machine learning primitives are basic operations that are commonly performed by machine learning algorithms. Without the machine learning framework 904, developers of machine learning algorithms would be required to create and optimize the main computational logic associated with the machine learning algorithm, then re-optimize the computational logic as new parallel processors are developed. Instead, the machine learning application can be configured to perform the necessary computations using the primitives provided by the machine learning framework 904. Exemplary primitives include tensor convolutions, activation functions, and pooling, which are computational operations that are performed while training a convolutional neural network (CNN). The machine learning framework 904 can also provide primitives to implement basic linear algebra subprograms performed by many machine-learning algorithms, such as matrix and vector operations.

The machine learning framework 904 can process input data received from the machine learning application 304 and generate the appropriate input to a compute framework 906. The compute framework 906 can abstract the underlying instructions provided to a GPGPU driver 908 to enable the machine learning framework 904 to take advantage of hardware acceleration via the GPGPU hardware 910 without requiring the machine learning framework 904 to have intimate knowledge of the architecture of the GPGPU hardware 910. Additionally, the compute framework 906 can enable hardware acceleration for the machine learning framework 904 across a variety of types and generations of the GPGPU hardware 910.

Machine Learning Neural Network Implementations

The computing architecture provided by embodiments described herein can be configured to perform the types of parallel processing that is particularly suited for training and deploying neural networks for machine learning. A neural network can be generalized as a network of functions having a graph relationship. As is well-known in the art, there are a variety of types of neural network implementations used in machine learning. One exemplary type of neural network is the feedforward network, as previously described.

A second exemplary type of neural network is the Convolutional Neural Network (CNN). A CNN is a specialized feedforward neural network for processing data having a known, grid-like topology, such as image data. Accordingly, CNNs are commonly used for computer vision and image recognition applications, but they also may be used for other types of pattern recognition such as speech and language processing. The nodes in the CNN input layer are organized into a set of “filters” (e.g., filters are feature detectors inspired by the receptive fields found in the retina), and the output of each set of filters is propagated to nodes in successive layers of the network. The computations for a CNN include applying the convolution mathematical operation to each filter to produce the output of that filter. Convolution is a specialized kind of mathematical operation performed by two functions to produce a third function that is a modified version of one of the two original functions. In convolutional network terminology, the first function to the convolution can be referred to as the input, while the second function can be referred to as the convolution kernel. The output may be referred to as the feature map. For example, the input to a convolution layer can be a multidimensional array of data that defines the various color components of an input image. The convolution kernel can be a multidimensional array of parameters, where the parameters are adapted by the training process for the neural network.

Recurrent neural networks (RNNs) are a family of feedforward neural networks that include feedback connections between layers. RNNs enable modeling of sequential data by sharing parameter data across different parts of the neural network. The architecture for a RNN includes cycles. The cycles represent the influence of a present value of a variable on its own value at a future time, as at least a portion of the output data from the RNN is used as feedback for processing subsequent input in a sequence. This feature makes RNNs particularly useful for language processing due to the variable nature in which language data can be composed.

The figures described herein may present exemplary feedforward, CNN, and RNN networks, as well as describe a general process for respectively training and deploying each of those types of networks. It will be understood that these descriptions are exemplary and non-limiting as to any specific embodiment described herein and the concepts illustrated can be applied generally to deep neural networks and machine learning techniques in general.

The exemplary neural networks described above can be used to perform deep learning. Deep learning is machine learning using deep neural networks. The deep neural networks used in deep learning are artificial neural networks composed of multiple hidden layers, as opposed to shallow neural networks that include only a single hidden layer. Deeper neural networks are generally more computationally intensive to train. However, the additional hidden layers of the network enable multistep pattern recognition that results in reduced output error relative to shallow machine learning techniques.

Deep neural networks used in deep learning typically include a front-end network to perform feature recognition coupled to a back-end network which represents a mathematical model that can perform operations (e.g., object classification, speech recognition, etc.) based on the feature representation provided to the model. Deep learning enables machine learning to be performed without requiring hand crafted feature engineering to be performed for the model. Instead, deep neural networks can learn features based on statistical structure or correlation within the input data. The learned features can be provided to a mathematical model that can map detected features to an output. The mathematical model used by the network is generally specialized for the specific task to be performed, and different models will be used to perform different tasks.

Once the neural network is structured, a learning model can be applied to the network to train the network to perform specific tasks. The learning model describes how to adjust the weights within the model to reduce the output error of the network. Backpropagation of errors is a common method used to train neural networks. An input vector is presented to the network for processing. The output of the network is compared to the desired output using a loss function and an error value is calculated for each of the neurons in the output layer. The error values are then propagated backwards until each neuron has an associated error value which roughly represents its contribution to the original output. The network can then learn from those errors using an algorithm, such as the stochastic gradient descent algorithm, to update the weights of the of the neural network.

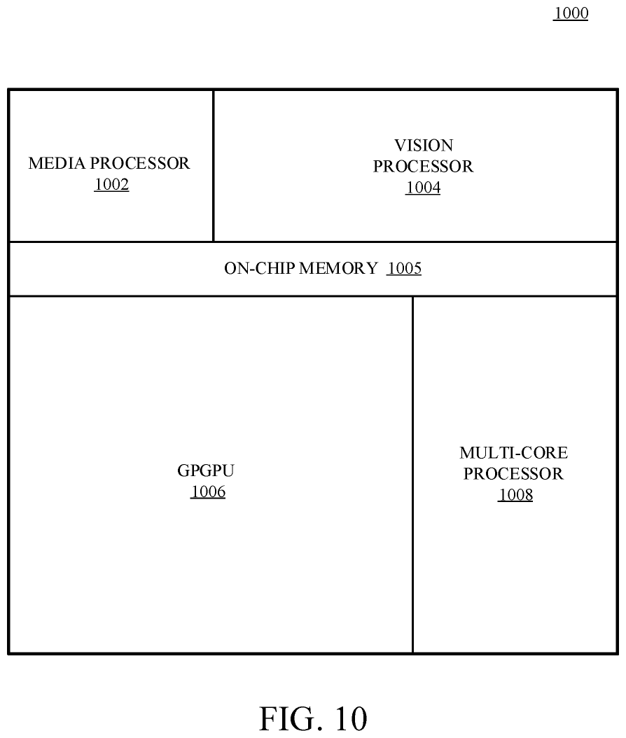

FIG. 10 illustrates an exemplary inferencing system on a chip (SOC) 1000 suitable for performing inferencing using a trained model. One or more components of FIG. 10 may be used to implement ML application 304. The SOC 1000 can integrate processing components including a media processor 1002, a vision processor 1004, a GPGPU 1006 and a multi-core processor 1008. The SOC 1000 can additionally include on-chip memory 1005 that can enable a shared on-chip data pool that is accessible by each of the processing components. The processing components can be optimized for low power operation to enable deployment to a variety of machine learning platforms, including autonomous vehicles and autonomous robots. For example, one implementation of the SOC 1000 can be used as a portion of the main control system for an autonomous vehicle. Where the SOC 1000 is configured for use in autonomous vehicles the SOC is designed and configured for compliance with the relevant functional safety standards of the deployment jurisdiction.

During operation, the media processor 1002 and vision processor 1004 can work in concert to accelerate computer vision operations (such as for ML application 304). The media processor 1002 can enable low latency decode of multiple high-resolution (e.g., 4K, 8K) video streams. The decoded video streams can be written to a buffer in the on-chip-memory 1005. The vision processor 1004 can then parse the decoded video and perform preliminary processing operations on the frames of the decoded video in preparation of processing the frames using a trained image recognition model. For example, the vision processor 1004 can accelerate convolution operations for a CNN that is used to perform image recognition on the high-resolution video data, while back-end model computations are performed by the GPGPU 1006.

The multi-core processor 1008 can include control logic to assist with sequencing and synchronization of data transfers and shared memory operations performed by the media processor 1002 and the vision processor 1004. The multi-core processor 1008 can also function as an application processor to execute software applications that can make use of the inferencing compute capability of the GPGPU 1006. For example, at least a portion of ML application can be implemented in software executing on the multi-core processor 1008. Such software can directly issue computational workloads to the GPGPU 1006 or the computational workloads can be issued to the multi-core processor 1008, which can offload at least a portion of those operations to the GPGPU 1006.

Flowcharts representative of example hardware logic, machine readable instructions, hardware implemented state machines, and/or any combination thereof for implementing computing device 800, for example, are shown in FIG. 2. The machine-readable instructions may be one or more executable programs or portion(s) of an executable program for execution by a computer processor such as the processor 814 shown in the example computing device 800 discussed above in connection with FIG. 8. The program may be embodied in software stored on a non-transitory computer readable storage medium such as a CD-ROM, a floppy disk, a hard drive, a DVD, a Blu-ray disk, or a memory associated with the processor 812, but the entire program and/or parts thereof could alternatively be executed by a device other than the processor 812 and/or embodied in firmware or dedicated hardware. Further, although the example program is described with reference to the flowchart illustrated in FIG. 2, many other methods of implementing the example ML application 304 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine-readable instructions described herein may be stored in one or more of a compressed format, an encrypted format, a fragmented format, a compiled format, an executable format, a packaged format, etc. Machine-readable instructions as described herein may be stored as data (e.g., portions of instructions, code, representations of code, etc.) that may be utilized to create, manufacture, and/or produce machine executable instructions. For example, the machine-readable instructions may be fragmented and stored on one or more storage devices and/or computing devices (e.g., servers). The machine-readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine-readable instructions may be stored in multiple parts, which are individually compressed, encrypted, and stored on separate computing devices, wherein the parts when decrypted, decompressed, and combined form a set of executable instructions that implement a program such as that described herein.

In another example, the machine-readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine-readable instructions may be configured (e.g., settings stored, data input, network addresses recorded, etc.) before the machine-readable instructions and/or the corresponding program(s) can be executed in whole or in part. Thus, the disclosed machine-readable instructions and/or corresponding program(s) are intended to encompass such machine-readable instructions and/or program(s) regardless of the particular format or state of the machine-readable instructions and/or program(s) when stored or otherwise at rest or in transit.

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example processes shown in the Figures may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended.

The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

The following examples pertain to further embodiments. Example 1 is a method of partitioning a deep neural network (DNN) model into one or more sets of one or more private layers and one or more sets of one or more public layers, a set of one or more private layers being at least one key in a cryptographic system; and deploying the partitioned DNN model on one or more computing systems.

In Example 2, the subject matter of Example 1 can optionally include wherein a set of one or more public layers functions as a public key and a set of one or more private layers functions as a corresponding private key.

In Example 3, the subject matter of Example 2 can optionally include determining the set of one or more private layers using adversarial training of the DNN model, with adversaries having read-only access to the set of one or more public layers.

In Example 4, the subject matter of Example 3 can optionally include wherein. defining one or more adversarial models, the one or more adversarial models having adversarial substitutions replacing the one or more private layers.

In Example 5, the subject matter of Example 4 can optionally include iteratively partitioning and training the DNN model and the one or more adversarial models until a maximum number of training iterations is reached or a training goal is met.

In Example 6, the subject matter of Example 5 can optionally include wherein the training goal is reached when a minimum of losses of the DNN model minus a minimum of losses of the adversarial model is less than a target delta value.

In Example 7, the subject matter of Example 1 can optionally include wherein. wherein the DNN model comprises a mask regional convolutional neural network (MRCNN) having a plurality of heads, each head including a set of one or more private layers different than a set of one or more private layers of other heads of the MRCNN.

Example 8 is at least one non-transitory machine-readable storage medium comprising instructions that, when executed, cause at least one processing system to partition a deep neural network (DNN) model into one or more sets of one or more private layers and one or more sets of one or more public layers, a set of one or more private layers being at least one key in a cryptographic system; and deploy the partitioned DNN model.

In Example 9, the subject matter of Example 8 can optionally include wherein a set of one or more public layers functions as a public key and a set of one or more private layers functions as a corresponding private key.

In Example 10, the subject matter of Example 9 can optionally include instructions that, when executed, cause at least one processing system to determine the set of one or more private layers using adversarial training of the DNN model, with adversaries having read-only access to the set of one or more public layers.

In Example 11, the subject matter of Example 10 can optionally include instructions that, when executed, cause at least one processing system to define one or more adversarial models, the one or more adversarial models having adversarial substitutions replacing the one or more private layers.

In Example 12, the subject matter of Example 9 can optionally include instructions that, when executed, cause at least one processing system iteratively partition and train the DNN model and the one or more adversarial models until a maximum number of training iterations is reached or a training goal is met.

Example 13 is a system comprising means for partitioning a deep neural network (DNN) model into one or more sets of one or more private layers and one or more sets of one or more public layers, a set of one or more private layers being at least one key in a cryptographic system; and deploying the partitioned DNN model on one or more computing systems.

In Example 14, the subject matter of Example 13 can optionally include wherein a set of one or more public layers functions as a public key and a set of one or more private layers functions as a corresponding private key.

In Example 15, the subject matter of Example 14 comprises means for executing the set of one or more private layers in a protected execution environment of a cloud computing system; and means for executing the set of one or more public layers in an unprotected execution environment of a user computing system.

In Example 16, the subject matter of Example 14 can optionally include means for executing the set of one or more private layers in a protected execution environment of a user computing system; and means for executing the set of one or more public layers in an unprotected execution environment of a cloud computing system.

In Example 17, the subject matter of Example 14 can optionally include means for executing the set of one or more private layers in a protected execution environment of a user computing system and means for executing the set of one or more public layers in an unprotected execution environment of the user computing system.

In Example 18, the subject matter of Example 14 can optionally include means for determining the set of one or more private layers using adversarial training of the DNN model, with adversaries having read-only access to the set of one or more public layers.

In Example 19, the subject matter of Example 14 can optionally include means for defining one or more adversarial models, the one or more adversarial models having adversarial substitutions replacing the one or more private layers.

In Example 20, the subject matter of Example 19 can optionally include means for iteratively partitioning and training the DNN model and the one or more adversarial models until a maximum number of training iterations is reached or a training goal is met.

In Example 21, the subject matter of Example 20 can optionally include wherein the training goal is reached when a minimum of the DNN model losses minus a minimum of the adversarial model losses is less than a target delta value.

In Example 22, the subject matter of Example 21 can optionally include wherein the DNN model comprises a mask regional convolutional neural network (MRCNN) having a plurality of heads, each head including a set of one or more private layers different than a set of one or more private layers of other heads of the MRCNN.

The foregoing description and drawings are to be regarded in an illustrative rather than a restrictive sense. Persons skilled in the art will understand that various modifications and changes may be made to the embodiments described herein without departing from the broader spirit and scope of the features set forth in the appended claims.

What is claimed is:

1. A computer-implemented method comprising:
partitioning a deep neural network (DNN) model into one or more sets of one or more private layers and one or more sets of one or more public layers, a set of one or more private layers being at least one key in a cryptographic system; and
deploying the partitioned DNN model on one or more computing systems.

2. The computer-implemented method of claim 1, wherein a set of one or more public layers functions as a public key and a set of one or more private layers functions as a corresponding private key.

3. The computer-implemented method of claim 2, comprising:
determining the set of one or more private layers using adversarial training of the DNN model, with adversaries having read-only access to the set of one or more public layers.

4. The computer-implemented method of claim 3, comprising:
defining one or more adversarial models, the one or more adversarial models having adversarial substitutions replacing the one or more private layers.

5. The computer-implemented method of claim 4, comprising:
iteratively partitioning and training the DNN model and the one or more adversarial models until a maximum number of training iterations is reached or a training goal is met.

6. The computer-implemented method of claim 5, wherein the training goal is reached when a minimum of losses of the DNN model minus a minimum of losses of the adversarial model is less than a target delta value.

7. The computer-implemented method of claim 1, wherein the DNN model comprises a mask regional convolutional neural network (MRCNN) having a plurality of heads, each head including a set of one or more private layers different than a set of one or more private layers of other heads of the MRCNN.

8. At least one non-transitory machine-readable storage medium comprising instructions that, when executed, cause at least one processing system to:
partition a deep neural network (DNN) model into one or more sets of one or more private layers and one or more sets of one or more public layers, a set of one or more private layers being at least one key in a cryptographic system; and
deploy the partitioned DNN model.

9. The at least one non-transitory machine-readable storage medium of claim 8, wherein a set of one or more public layers functions as a public key and a set of one or more private layers functions as a corresponding private key.

10. The at least one non-transitory machine-readable storage medium of claim 9, comprising instructions that, when executed, cause at least one processing system to:
determine the set of one or more private layers using adversarial training of the DNN model, with adversaries having read-only access to the set of one or more public layers.

11. The at least one non-transitory machine-readable storage medium of claim 10, comprising instructions that, when executed, cause at least one processing system to:
define one or more adversarial models, the one or more adversarial models having adversarial substitutions replacing the one or more private layers.

12. The at least one non-transitory machine-readable storage medium of claim 11, comprising instructions that, when executed, cause at least one processing system to:
iteratively partition and train the DNN model and the one or more adversarial models until a maximum number of training iterations is reached or a training goal is met.

13. A system comprising:
a processing device; and
a memory device coupled to the processing device, the memory device having instructions stored thereon that, in response to execution by the processing device, cause the processing device to:
partition a deep neural network (DNN) model into one or more sets of one or more private layers and one or more sets of one or more public layers, a set of one or more private layers being at least one key in a cryptographic system; and
deploy the partitioned DNN model on one or more computing systems.

14. The system of claim 13, wherein a set of one or more public layers functions as a public key and a set of one or more private layers functions as a corresponding private key.

15. The system of claim 14, comprising:
a cloud computing system to execute the set of one or more private layers in a protected execution environment; and
a user computing system to execute the set of one or more public layers in an unprotected execution environment.

16. The system of claim 14, comprising:
a user computing system to execute the set of one or more private layers in a protected execution environment; and
a cloud computing system execute the set of one or more public layers in an unprotected execution environment.

17. The system of claim 14, comprising:
a user computing system to execute the set of one or more private layers in a protected execution environment and to execute the set of one or more public layers in an unprotected execution environment.

18. The system of claim 14, comprising the memory device having instructions stored thereon that, in response to execution by the processing device, cause the processing device to:
determine the set of one or more private layers using adversarial training of the DNN model, with adversaries having read-only access to the set of one or more public layers.

19. The system of claim 14, comprising the memory device having instructions stored thereon that, in response to execution by the processing device, cause the processing device to:
define one or more adversarial models, the one or more adversarial models having adversarial substitutions replacing the one or more private layers.

20. The system of claim 19, comprising the memory device having instructions stored thereon that, in response to execution by the processing device, cause the processing device to:
iteratively partition and train the DNN model and the one or more adversarial models until a maximum number of training iterations is reached or a training goal is met.

21. The system of claim 20, wherein the training goal is reached when a minimum of the DNN model losses minus a minimum of the adversarial model losses is less than a target delta value.

22. The system of claim 14, wherein the DNN model comprises a mask regional convolutional neural network (MRCNN) having a plurality of heads, each head including a set of one or more private layers different than a set of one or more private layers of other heads of the MRCNN.
